(19) United States
(12) Patent Application Publication
(10) Pub. No.: US 2002/0107783 A1
(43) Pub. Date: Aug. 8, 2002

(54) System and method for online virtual collections

(75) Inventors: Pierfrancesco La Mura, Palo Ato, CA (US); Moshe Tennenholtz, Palo Alto, CA (US); Yoav Shoham, Palo Aito, CA (US)

Correspondence Address: Andrew D. Gathy, Sierra Patent Group, Ltd., P.O. Box 6149, Stateline, NV, 89449, US

(73) Assignee: CGtime, Inc

(21) Appl. No.: 09/940,680

(22) Filed: Aug. 27, 2001

Related U.S. Application Data
(60) Provisional application No. 60/231,728, filed on Sep. 11, 2000.

(51) Int. Cl. G06F 17/60

(52) U.S. Cl. 705/37

(57) ABSTRACT

A system for online virtual collections is disclosed. The online collection system having at least one participant, the online collection system comprising an online collection distribution module configured to allocate items to at least one participant. The online collection system having an online collection bank module operatively coupled to the online collection distribution module, the online collection bank module configured to maintain online collectibles in a database of the at least one participant. The online collection system having an online collection exchange module operatively coupled to the online collection distribution module, the online collection exchange module configured to trade online collectibles. The online collection system having an online collection redemption module operatively coupled to the online collection distribution module, the online collection redemption module configured to redeem the online collectibles for prizes. The online collection system having a plurality of online collectibles operatively coupled for communication to the online collection bank module. A method for online virtual collections is also disclosed.

### PRIOR APPLICATION

This application claims priority of a Provisional Application No. 60/231,728, filed Sep. 11, 2001.

### BACKGROUND OF THE INVENTION

1. Field of the Invention

This invention pertains generally to online loyalty systems, the integration of off-line and on-line activities, and brand-mediated consumer interactions. More particularly, the invention is a system and method for distributing, managing, trading, and redeeming “non-linear, multi-dimensional” online virtual collections which promotes online traffic and activity, makes loyalty programs and other reward programs more entertaining and amusing, and generally complements and enhances existing marketing practices in electronic commerce. In addition, the invention brings the excitement of items collection and trading to communities where no physical collectibles currently exist.

2. The Prior Art

The collection of pieces of a puzzle, allocated while making a purchase, in order to get some prizes, has been the subject of some of the most successful promotions. Trading pieces of the puzzle is a most engaging activity for many customers. This promotion can be considered as a successful form of a loyalty program. On the other hand, loyalty programs having the Internet setup have concentrated on points' programs, where a purchase is followed by the allocation of points, the number of which to be allocated is determined by the value of the purchase. These loyalty points can be considered as a degenerate form of a collection, where pieces are only of one type, the value of a set of points is linear in their number, and the allocation of points is fully deterministic.

In addition to employing loyalty programs that are to deal with on-line activities, many brand-name companies and mass retailers are currently pursuing ways of transferring their sales and marketing activities to the Internet, in order to yield more efficient and beneficial transactions, provide their customers with a feeling of a community, and better follow their preferences and habits. Nonetheless, current loyalty programs typically follow the conventional linear, single-dimensional style of loyalty program.

### BRIEF DESCRIPTION OF THE INVENTION

In order to overcome the deficiencies found in the background art, the present invention provides an online virtual collectibles system where virtual pieces of a puzzle are allocated based on the execution of desired off-line and/or on-line activities, the virtual pieces of a puzzle are maintained in an on-line account and can be traded over the globe in order to obtain desired prizes. This invention provides a novel idea that allows a company to better follow its customers, while introducing a most novel but natural loyalty program. The online collection system allows the allocation of credits for a wide variety of activities, the establishment of a community around a company's web-site, as well as establishing connections between off-line and on-line activities. This allows for creating branded market-like interactions among consumers without the need for trading physical goods.

An online (virtual) collection is a set of electronic items, such as, for instance, electronic images of football celebrities and the like. Once a participant, user or player, (hereinafter participant), registers with the system, an account is set up in the central server. Then, electronic items (collectibles) assigned to a participant (player) is put in his or her account. The items are stored in individual participants accounts at a central server. One way to store the electronic items is in an on-line flipbook where virtual collectibles are stored, and can be looked at by other participants as well. The electronic items can be acquired in a variety of ways, for instance, as a reward for an online or offline transaction, for visiting a web page, or for winning an online game.

There is a value associated with each subset of electronic items. The value is expressed in terms of money, or of some arbitrary currency unit internal to the online collection system, or as predetermined prizes that are attached to each subset of electronic items. For some predetermined subsets (e.g., complete or semi-complete collections), the value is higher than the sum of the values of the individual electronic items in the subset. For instance, the value of a complete collection of images of San Francisco 49ers may be higher than the value of the sum of all of the individual images.

The online collection system includes individual accounts at a central server, where the collection items can be uniquely identified and deposited; of rewards attached to each subset of electronic items, and means to redeem the electronic items and perceive the corresponding rewards; and of an exchange platform, where the participants can barter collection items.

An example exchange platform is designed in the following way: the participants, from the client's website notify the online collection system of the electronic items they are willing to exchange for other electronic items, and periodically the online collection system “clears the market” by means of an efficient matching mechanism. A matching mechanism is efficient if it only effects mutually advantageous exchanges, and excludes disadvantageous exchanges. Another example exchange platform allows for participant-driven clearing, where participants can negotiate the terms of exchange by either a chat capability or by a formal communication language. The online collection system supports various novel types of exchanges such as circular trading and heterogeneous trades (which refer to both electronic items and points).

Under this arrangement, this online collection system promotes online traffic and activity, makes loyalty programs and other reward programs more entertaining and amusing, and generally complements and enhances existing marketing practices in electronic commerce.

The invention further relates to machine readable media on which are stored embodiments of the present invention. It is contemplated that any media suitable for retrieving instructions is within the scope of the present invention. By way of example, such media may take the form of magnetic, optical, or semiconductor media. The invention also relates to data structures that contain embodiments of the present invention, and to the transmission of data structures containing embodiments of the present invention.

### BRIEF DESCRIPTION OF THE DRAWINGS

The present invention will be more fully understood by reference to the following drawings, which are for illustrative purposes only.

FIG. 1 is a block diagram depicting an exemplary online collection system in accordance with the present invention.

FIG. 2 is an exemplary tuple depicting a first tuple.

FIG. 3 is an exemplary tuple depicting a second tuple.

FIG. 4 is an exemplary tuple depicting a third tuple.

FIG. 5 is an exemplary tuple depicting a fourth tuple.

FIG. 6 is an exemplary tuple depicting a fifth tuple.

### DETAILED DESCRIPTION OF THE INVENTION

Persons of ordinary skill in the art will realize that the following description of the present invention is illustrative only and not in any way limiting. Other embodiments of the invention will readily suggest themselves to such skilled persons having the benefit of this disclosure.

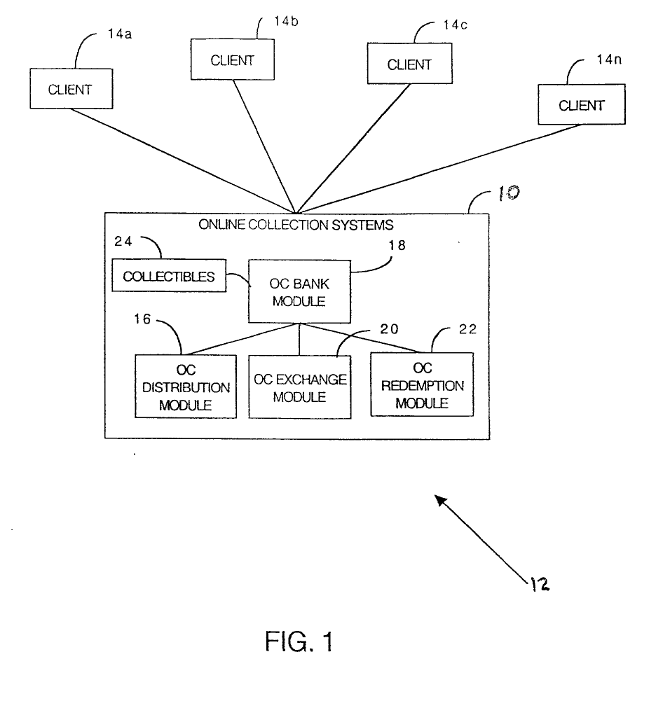

Referring more specifically to the drawings, for illustrative purposes the present invention is embodied in the exemplary apparatus shown in FIG. 1. It will be appreciated that the apparatus may vary as to configuration and as to details of the parts, and that the method may vary as to details and the order of the steps, without departing from the basic concepts as disclosed herein. The invention is disclosed generally in terms of an online collections system and method, although numerous other uses for the invention will suggest themselves to persons of ordinary skill in the art.

Referring first to FIG. 1, there is shown a functional block diagram of an illustrative online collection system 10 in accordance with the present invention. The online collection system 10 operates within a network server 12 which can be any standard data processing means or computer, including a minicomputer, a microcomputer, a UNIX® machine, a mainframe machine, a personal computer (PC) such as INTEL® based processing computer or clone thereof, an APPLE® computer or clone thereof or, a SUN® workstation, or other appropriate computer.

Server 12 generally includes conventional computer components (not shown), such as a motherboard, a central processing unit (CPU), random access memory (RAM), hard drive, display adapter, other storage media such as diskette drive, CD-ROM, flash-ROM, tape drive, PCMCIA cards and/or other removable media, a monitor, keyboard, mouse and/or other participant interface means, a modem, network interface card (NIC), and/or other conventional input/output devices. The server 12 has loaded in its RAM a conventional server operating system (not shown) such as UNIX®, WINDOWS® NT, NOVELL®, SOLARIS®, LINUX or other server operating system. Server 12 also has loaded in its RAM web server software (not shown) such as APACHE®, NETSCAPE®, INTERNET INFORMATION SERVER™ (IIS), or other appropriate web server software loaded for handling HTTP (hypertext transfer protocol) or Web page requests.

In accordance with the invention, online collection system 10 operates in a network environment of network server 12. The network server 12 may be any conventional network suitable for coupling online collection system 10 with a plurality of client nodes 14a through 14n.

Server 12 is operatively coupled for communication to at least one client node 14a, although typically server 12 will be coupled to a plurality of nodes (14a through 14n), each operatively coupled for communication with the online collection system 10, as shown in FIG. 1. Each client node 14a through 14n, like server 12, preferably comprises a standard computer such as a minicomputer, a microcomputer, a UNIX® machine, mainframe machine, personal computer (PC) such as INTEL®, APPLE®, or SUN® based processing computer or clone thereof, or other appropriate computer.

Each client node 14a through 14n also includes typical computer components (not shown), such as a motherboard, central processing unit (CPU), random access memory (RAM), hard disk drive, display adapter, other storage media such as diskette drive, CD-ROM, flash-ROM, tape drive, PCMCIA cards and/or other removable media, a monitor, keyboard, mouse and/or other participant interface means, a modem, network interface card (NIC), and/or other conventional input/output devices. Each client node 14a through 14n also has loaded in its RAM an operating system (not shown) such as UNIX®, WINDOWS® 98 or the like. Each client node 14a through 14n further has loaded in RAM a Web Browser program (not shown) such as NETSCAPE®, INTERNET EXPLORER®, AOL®, or like browsing software for client computers.

Each client node 14a through 14n is normally embodied in a conventional desktop or “tower” machine, but can alternatively be embodied in a portable or “laptop” computer, a handheld personal digital assistant (PDA), a cellular phone capable of browsing Web pages, a dumb terminal capable of browsing Web pages, an internet terminal capable of browsing Web pages such as WEBTV®, or other Web browsing devices.

Each client node 14a through 14n is networked for communication with server 12. Typically, a client node is operatively coupled to communicate with server 12 via the Internet through a phone connection using a modem and telephone line (not shown), in a standard fashion. A client node may alternatively be coupled to server 12 via a network (e.g., LAN, WAN, etc.) connection. It will be apparent to those skilled in the art having the benefit of this disclosure that alternative means for networking clients 14a through 14n and server 12 may also be utilized, such as a direct point to point connection using modems, satellite connection, direct port to port connection utilizing infrared, serial, parallel, USB, FireWire/IEEE-1394, and other means known in the art. Generally, client nodes 14a through 14n and server 12 communicate using the TCP/IP (transfer control protocol/internet protocol). However, other protocols for communication may also be utilized, including PPTP, NetBEUI over TCP/IP, voice-based protocols, and other appropriate network protocols.

While depicted as a single computer for purposes of disclosing an exemplary embodiment of the present invention, server 12 may comprise a plurality of servers (i.e., a server farm) to provide robust services to the client nodes 14a through 14n, as is known in the art.

Still referencing FIG. 1, the online collection system 10 comprises an online collection (OC) distribution module 16 (mechanism for the allocation of items, termed collectibles, to participants, based on requests made by a client) operatively coupled to an OC bank module 18 (mechanism for maintaining on-line collectibles in a participant's database), and an OC exchange module 20 (mechanism for trading of on-collectibles among participants ) operatively coupled to the OC distribution system 16, and an OC redemption module 22 (mechanism for redeeming collectibles for prizes).

A plurality of collectibles 24 is further provided by the online collection system 10 and is operatively coupled for communication to the OC bank module 18.

Referring to FIG. 2, a collectible 24 may be represented in a first tuple 26 of the form <key, value, content, date, constraints>, where: key is a unique identifier (e.g. a serial number); value is a unique identifier of a piece content (e.g. puzzle piece number “X” in a puzzle); content is the actual description of the piece (e.g., a visual representation of a collectible); date is the date and/or the time when this piece is valid and can be used; and constraints are further restrictions on who can hold the piece, whether and when the piece can be traded, and the like.

A set of collectibles is associated with a certain prize or a certain value. For example, if the content of each piece is a part of a whole picture representing an image of a football player A, then a participant that acquires of all of the pieces of the picture of player A may redeem all of the pieces of the picture for a T-shirt. In another example a participant that gathers all of the pictures of all of the players that belong to a team, may redeem all of the pictures for a free entrance to all of the games of that team for a season.

Contrasted with points, which are common in existing loyalty programs, a collection of collectibles is multi-dimensional and the value of a collection is nonlinear. For example, each piece of a picture (puzzle) can be considered as different types of points, and only by having a particular number of points from each type may the participant get a desired prize. This illustrates that a collection of collectibles is multi-dimensional. The non-linearity of the value can be illustrated as follows: two strict subsets of the pieces of a picture may be worth nothing, while having the whole picture will yield a prize. Another example of nonlinearity is when the prize for having a complete picture of all 25 team players is worth $2500, while the prize for having the complete picture of each single player is worth $10. In general, two or more collectible items when aggregated have a higher value than the non-aggregated value of the individual items.

The OC distribution module 16 carries out the operation of generating and allocating collectibles. The online collectibles system 10 will get a request from a client for allocating a set of collectibles for a participant. The request will be initiated as a result of a purchase, visiting a client's web site, referring another participant, or any other activity that the client may wish the participant to get credit for.

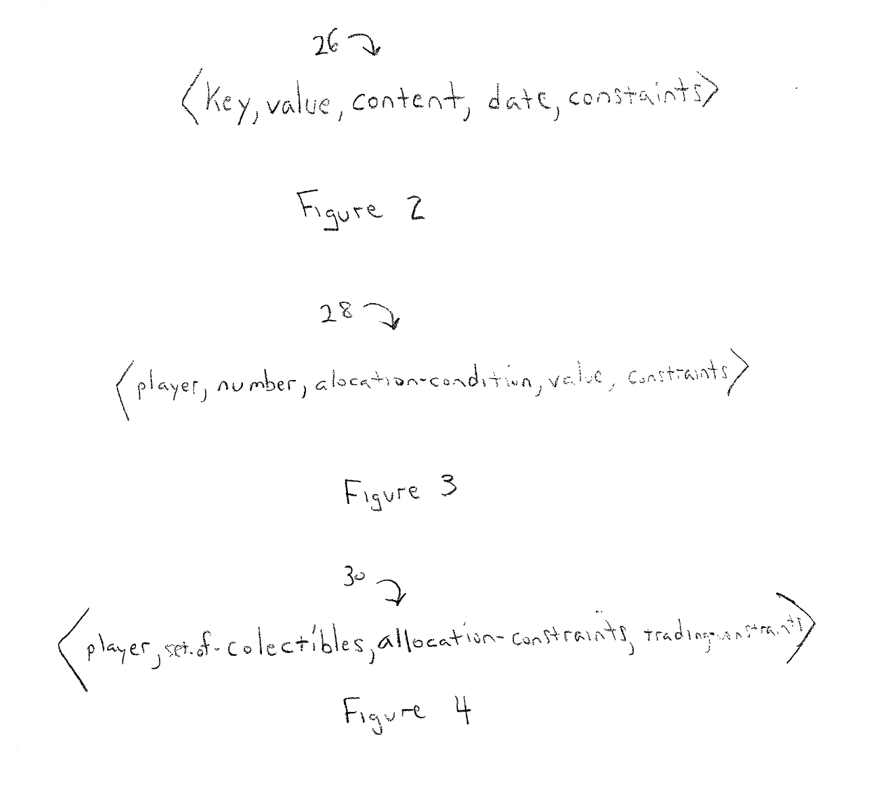

Referencing FIG. 3, the request from a client may be in the form of a second tuple 28, <player, number, allocation-condition, value-onstraints>, where: player is a unique identifier of a participant; number is the number of pieces to be allocated to the player (the number can vary, and may depend on allocation conditions); allocation-condition is a condition for the allocation of the collectibles (e.g. a request for answering a trivia question; the allocation-condition may also determine the number of allocated pieces and put value-constraints); value-constraints are constraints on the allocation of pieces (e.g. pieces of a particular form only should be allocated, etc.).

A request for generating collectibles may be initiated in one of several ways. First, the request may be initiated by a click-through from a client's web site. In this case, certain allocation conditions will be checked by the client's system and the control will move to the online collection system only after these are checked (e.g. answering correctly a trivia question will generate the click-through to the online collection system), while other allocation conditions will be checked by the online collection system (e.g. the online collection system will create a trivia question from a category specified by the client, and will check for the correctness of the answer). In a case that a participant can obtain collectibles only a limited number of times, by a click-through from a particular entry on a page, an appropriate allocation-condition can be provided.

The request for generating collectibles may be initiated by data entry of an identifier/key gathered through off-line purchase, or through other off-line or online activity. Typically, the identifiers will be entered from the client's web site, which will initiate a request for obtaining collectibles through the online collection system as described above.

Referencing FIG. 4, the OC bank module 18 maintains a database of participants and the collectibles they hold. A sample entry may have the form of a third tuple 30, <player,set-of-collectibles,allocation-constraints,trading-constraints>, where: player is a unique identifier of the participant; set-of-collectibles are the keys and values of the pieces held by the player; allocation-constraints are constraints on the allocation of pieces to that player (for example based on geographic location); and trading-constraints are constraints on the types of trades the player may be involved with (this should be added to the trading constraints for particular collectibles). Collectibles which expire after their expiration date will be automatically removed from the online collection system.

The online collection system supports the maintenance of a bank account as an on-line flipbook. The flipbook can be organized in various ways, allowing the participant to specify the way their collectibles will be viewed by them, as well as by other participants. The flipbook contains special areas for new incoming collectibles, a trade-list where collectibles the participant may wish to trade appears, as well as a wish-list where collectibles the participant is seeking may appear. The online collection system also supports search and browse capabilities that allow the participant to search or browse the flipbook of other participants. The online collection system supports constraints on the search and browse capabilities. In particular, various forms of searching and browsing are limited only to a buddy-list of participants that a participant may specify.

The OC exchange module 20 is configured to allow both automatic and participant-driven barters. The automatic barter matches offers based on a predefined matching algorithm. The participant-driven barter, (user-driven barter), allows participants to trade by explicitly negotiating with one another, and allows both bi-lateral and multi-lateral trading.

In an automatic barter, the exchange module is configured to allow each participant to have (at each point in time, or along a specified period) at most K(.) offers for collectibles exchange. K will be a function of the participant identity and additional constraints (e.g. time left before the event ends).

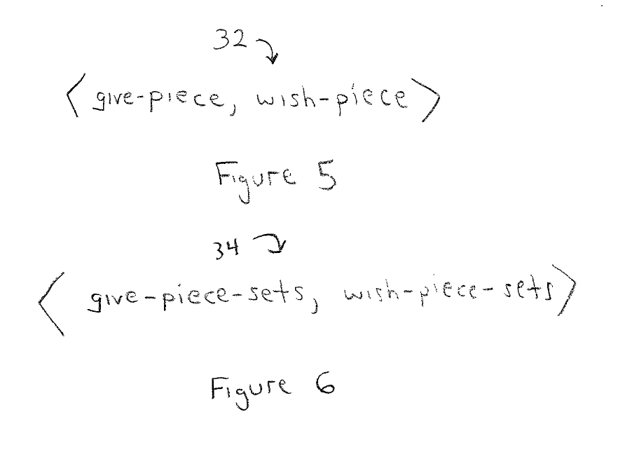

Referencing FIG. 5, a simple exchange offer may be in the form of a fourth tuple 32, in the following form: <give-piece,wish-piece>, where give-piece is a piece held by the player; and wish-piece is a piece he/she may like to get.

Referring to FIG. 6, the online collection system 10 also supports more complex offers that can be in the form of a fifth tuple 34, in the form: <give-piecesets,wish-piece-sets>, where give-piece-sets and wish-piece-sets are groups of sets of pieces with the interpretation that the player is willing to give a set of pieces mentioned in the give-piece sets in exchange for a set in the wish-piece-sets.

In addition, the online collection system supports various forms of multilateral trading offers. In particular it allows conditional trades and simultaneous offers. In a conditional trade a participant specifies that he/she will trade a set of pieces A for another set of pieces B only if a set of pieces C will be traded for a set of pieces D. In simultaneous offers the participant can specify identical or overlapping offers to different participants, and the online collection system will ensure that once an offer has been accepted the other identical/overlapping offers will be removed.

When applying an automatic barter, the online collection system ensures that the complex offer refers to no more than K(.) pieces. The online collection system allows participants to remove offers. An offer that has been removed will be taken into account when counting the number of offers that have been made along a period. The online collection system maintains a database of existing offers for the automatic barter and will match them in a variety of ways. One way the online collection system matches existing offers is through a continuous double auction. In the continuous double auction pairs of exchange offers are matched. Matching will be carried out whenever a new offer arrives, and matches an existing offer. If this offer matches several offers then the earliest offer will be selected.

Another way the online collection system matches existing offers is through a periodic clearing procedure for matching exchange offers. The periodic clearing procedure takes into account both the time of the offer, as well as other parameters, such as further priority for participants who have made frequent purchases, and the like.

Yet another way the online collection system matches existing offers is through the matching of exchange offers in one of the above ways, while taking into account demographic issues.

Offers that refer to collectibles that have been expired (according to the date parameter in the definition of the collectible) will be automatically removed. In addition, some collectibles might not be traded (or might not be traded on particular dates, etc.), as prescribed by their definition.

In the participant-driven barter, a participant is able to submit an exchange offer to one or more other participants. Participants may accept offers or send counter-offers. The online collection system supports both a chat capability as well as a formal negotiation language (see below) to facilitate trading.

The OC redemption module 22 provides redemption of collections for prizes or other value. The online collection system will maintain a list of prizes, and a mapping from sets of collectibles to prizes. For example, this mapping may specify that every participant who gets all letters in the name “Commerce Games”, where the content of each collectible refers now to a letter, will get a free trip to Hawaii. The redemption period will be specified in advance, and the number of prizes available at each category will be made public. Participants will be informed which of the prizes are currently available at each point in time. The online collection system however supports other implementations, e.g. where the participants are informed about the prizes for each set of collectibles, but not about the number of prizes available at each category.

The method and operation of the invention will be more fully understood with reference to the process described herein. The order of actions as described below is only exemplary, and should not be considered limiting.

The online collection system has a distribution process. As a part of the distribution process the online collection system receives a request for the allocation of a number of collectibles for a participant. In general, the participant should be registered on the online collection system and other related systems. If allocation-conditions are specified, then the online collection system initiates a sub-process for testing these conditions (e.g. generating and checking related trivia questions). Given the results of checking the allocation-conditions and the allocation-constraints the online collection system randomly selects a number of pieces from the set of possible pieces. The number of pieces to be selected and the actual set from which they are selected are determined according to the results of the allocation-condition sub-process, the allocation constraints, and the initial distribution of the pieces. The selected pieces will be allocated to the on-line collectibles account of the corresponding participant. As part of the online collection system distribution process each generated piece will be assigned a unique key that will distinguish it from other pieces (and in particular from pieces of the same value). The online collection system supports various ways of key assignment. This will enable the management of information about the source of the request (e.g. the page from which a click-through to the online collection system has been generated); this can be used later as part of the allocation-condition (e.g. collectibles will not be assigned the second time the participant visits the same page). In the distribution process, the participant is informed about the collectibles that are allocated, the expiration date of the collectibles, and the collectibles database is updated respectively.

The online collectible system incorporates a maintenance process. As part of the maintenance process of the online collection system, when a participant registers with the online collection system, an entry in the online collectibles database is created for the participant database, (for example a data entry into the online collection bank). Some allocation-constraints will be implied by the registration process. As an example, allocation-constraints can be implied in the case of allocation that is based on demographics. Trading constraints will be marked in an entry associated with the particular participant. Whenever collectibles are assigned to a participant, they are put into his/her account. The update of the account may trigger additional allocation-constraints and trading-constraints (e.g. someone who has been allocated more than M pieces will get an opportunity for additional exchange offers). The additional allocation-constraints will be marked in an entry associated with the particular participant. As part of the maintenance process, collectibles will be removed from the collectibles bank on a periodic basis, based on their expiration date. With the maintenance process, the bank account of a participant will be accessible to the participant, as well as partially accessible to other participants. The access can be obtained by the flipbook mentioned above, that contains a special area of trade-list, wish-list, and incoming collectibles. A participant will be able to search or browse flipbooks of other participants, and get access to related information about their account. Access may be limited to a particular subset of the participants, the subset of participants may be termed a buddy-list. The online collection system will be able to configure the exact search and browse capabilities to be permitted, based on a client's requirements. For example, a participant may be allowed to search for items that appear in a trade-list of other participants but not in their wish-list. The online collection system can also have a trading process.

In the online collection system, the trading process can have a registered participant initiate an exchange offer as described above. The online collection system checks that the request refers to collectibles that have not been expired, and that the exchange offer is valid. The trading process validates if the participant has the collectibles he/she is willing to give in his/her account, and the number of collectibles that the participant asks to exchange fits the corresponding constraints as noted above. In the case of automatic barter with continuous clearing, the online collection system checks for a match between the request and the existing requests. In the case when there exists an appropriate match, the online collection system will select the earlier request that matches the participant's request in order to make the exchange. In the case of automatic barter with periodic clearing, the matching will take place at a well-defined and commonly known time of the day, and will consider simultaneously all of the offers. In automatic barter with periodic clearing the time an offer is made is also important.

Also with the trading process, in the case of automatic barter, the online collection system supports a clearing algorithm that allows for circular barters. In circular barter, participants will specify what they wish to trade (e.g. a particular piece). The online collection system can aggregate the pieces participants may wish to trade, as well as communicate this information to participants. Within the trading process each participant will be able to communicate which of these pieces the participant will agree to receive for his/her own piece.

An optimal matching algorithm will clear the market efficiently. The algorithm will maximize the number of participants who have traded their pieces successfully. As an example, when there are participants 1, 2, and 3 they may make the following exchange: piece A will move from participant 1 to participant 2, piece B will move from participant 2 to participant 3, and piece C will move from participant 3 to participant 1.

The trading process of the online collection system is configured for heterogeneous barters. Heterogeneous barters are barters where offers contain both pieces as well as other currency such as points. In the case of automatic barter, the online collection system supports a novel clearing algorithm for heterogeneous barters. As part of heterogeneous barter the participants can specify what they wish to trade (e.g. a particular piece). The online collection system aggregates the pieces the participants may wish to trade. After aggregating the pieces participants may wish to trade, and communicating to other system participants the information about the pieces that may be traded, each participant will be able to communicate which of these pieces the participant will agree to receive for his/her own piece. The trading process also allows for the additional payment (which might be positive, negative, or zero) he/she associates with this trade. The trading process allows a participant to specify that he/she is willing to perform a trade, assuming he/she will receive additional payment, as well as offer a particular payment in addition to his/her item in a particular trade.

The online collection system uses an optimal clearing mechanism. The optimal clearing mechanism maintains the relationship between participants such that no pair of participants will prefer to trade with one another rather than trade with their assigned partners.

Also within the trading process that utilizes participant-directed barters, the online collection system will support both conditional trades as well as simultaneous trades as described above. Simultaneous trades as well as conditional trades require the online collection system to remove particular offers when particular conditions arise.

The online collection system trading process can also support chat capabilities, as well as a formal language of trading. The chat capabilities and formal language of trading can be incorporated by system participants that are not online in order to leave offers and counter-offers. The communication language can be defined in many ways. For example, basic offers have the form (A for B), where the A and the B are sets of pieces or are a compound element as described below. A compound element has the form of a logical propositional formula with regard to sets of pieces. For example a compound element can be X OR Y, or U XOR V, where X, Y, U and V are corresponding sets of pieces, and OR and XOR correspond to “standard or” and “exclusive or” operators. An offer is built of a set (AND) of basic offers. For example, the language supports an offer of the form: ((A XOR B) for (C OR D)) AND (G for H), with the semantics that the participant is willing to give A or B, and only one of them, for either C or D, assuming the participant gets H for G, where A, B, C, D, G, and H are sets of pieces. The communication language supports counter-offers, that are based on similar syntax as above, as well as reject/accept messages.

The online collection system trading process that involves an exchange enforces the exchange by modifying the entries in the online collectibles bank associated with the corresponding set of participants. When an exchange takes place, the corresponding participants are notified about the exchange. When a participant removes an offer then the offer will not be included in the set of valid offers, and will not be used in the matching process.

The online collectible system incorporates a redemption process. The redemption process can be configured such that a registered participant can ask to be informed at each point in time about the prizes he/she can get based on the set of collectibles he/she currently holds. The corresponding query will generate a listing of all possible prizes the participant can potentially redeem given his/her collectibles at the given point (although not all of the prizes might be actually redeemed due to the fact some prizes might require the use of the same collectibles). The online collection system also supports a visual representation of the collectibles held by the participant. When a participant submits a “redeem” request for a particular prize, the online collection system will generate a transaction for handling the request, and modify the online collectibles bank account of the corresponding participant. When there is a change in the set of collectibles held by a participant, the set of prizes available will be modified as well. The online collection system supports expiration dates for prizes, as well as limitations on the number of units of each prize. These will also be mentioned in the answers to the participants' queries about the prizes they can obtain at a given point.

Accordingly, it will be seen that this invention provides a system and method for distributing, managing, trading, and redeeming “non-linear, multidimensional” online collections which promotes online traffic and activity, makes loyalty programs and other reward programs more entertaining and amusing, and generally complements and enhances existing marketing practices in electronic commerce. Although the description above contains many specifics, these should not be construed as limiting the scope of the invention but as merely providing an illustration of the presently preferred embodiment of the invention.

What is claimed is:

1. In a computer device, an online collection system having at least one participant, said online collection system comprising:
an online collection bank module, said online collection bank module configured to maintain online collectibles in a database of said at least one participant;
an online collection distribution module operatively coupled to said online collection bank module, said online collection distribution module configured to allocate items to said at least one participant
an online collection exchange module operatively coupled to said online collection bank module, said online collection exchange module configured to trade online collectibles;
an online collection redemption module operatively coupled to said online collection bank module, said online collection redemption module configured to redeem said online collectibles for prizes; and
a plurality of online collectibles operatively coupled for communication to said online collection bank module.

2. The online collection system as in claim 1, wherein said plurality of collectibles may be represented in a tuple, wherein said tuple includes identifiers selected from the group consisting of key, value, content, date and constraints.

3. A machine readable medium containing a data structure for a plurality of collectibles comprising a symbol having an indication therein for representing said plurality of collectibles.

4. The online collection system as in claim 1 wherein said plurality of online collectibles is associated with a value.

5. The online collection system as in claim 4, wherein said value is nonlinear.

6. The online collection system as in claim 1, wherein said plurality of collectibles are multidimensional.

7. The online collection system as in claim 1, wherein said online collection distribution module generates said plurality of collectibles.

8. The online collection system as in claim 1, wherein said online collection distribution module allocates said plurality of collectibles.

9. The online collection system as in claim 1, wherein said online collection system receives a request from a client, said request allocates at least one of said plurality of collectibles.

10. The online collection system as in claim 9, wherein said request can be in the form of a second tuple, wherein said second tuple includes identifiers selected from the group consisting of participant, number, allocation-condition and value-constraints.

11. A machine readable medium containing a data structure for a request for at least one of a plurality of collectibles comprising a symbol having an indication therein for representing said request for at least one of a plurality of collectibles.

12. The online collection system as in claim 9, wherein said request can be initiated by a click-through from said client's web site.

13. The online collection system as in claim 9, wherein said request can be initiated by data entry of at least one of a key obtained in and offline activity and an identifier.

14. The online collection system as in claim 1, wherein said online collection bank module maintains a database of said participants and maintains at least one of said plurality of collectibles said participants hold.

15. The online collection system as in claim 14, wherein said online collection bank module can maintain said database through a third tuple, wherein said third tuple includes identifiers selected from the group consisting of player, set-of-collectibles, allocation-constraints and trading-constraints.

16. The online collection system as in claim 1, wherein said online collection bank module removes at least one of said plurality of online collectibles upon expiration.

17. The online collection system as in claim 1, wherein said online collection bank module supports maintenance of a bank account as an online flipbook.

18. The online collection system as in claim 17, wherein said online collection bank module comprises programming associated with said online flipbook, said programming configured to allow participants to specify the way in which at least one of said plurality of collectibles can be viewed, said programming configured to contain areas for new incoming collectibles, said programming configured to provide a trade-list wherein at least one of said collectibles said participant makes available for trade can appear, said programming configured to provide a wish-list wherein at least one of said collectibles said participant is seeking can appear, said programming configured to provide search and browse capabilities, and said programming configured to provide search and browse constraints.

19. The online collection system as in claim 1, wherein said online collection exchange module is configured to allow at least one of an automatic barter and participant driven barter and heterogeneous barter.

20. The online collection system as in claim 19, wherein said automatic barter matches offers based on a pre-defined matching algorithm.

21. The online collection system as in claim 19, wherein said participant driven barter is configured to allow said participants to trade by explicitly negotiating.

22. The online collection system as in claim 19, wherein said participant driven barter is configured to allow at least one of bi-lateral and multi-lateral trading.

23. The online collection system as in claim 1, wherein said online collectibles exchange module is configured to allow f or an exchange offer, wherein said exchange offer can be in the form of a fourth tuple, said fourth tuple includes identifiers selected from the group consisting of give-piece, and wish-piece.

24. The online collection system as in claim 19, wherein said online collection exchange module is configured to provide complex offers, said complex offers can be in the form of a fifth tuple, wherein said fifth tuple includes identifiers selected from the group consisting of give-piece-sets and wish-piece-sets.

25. The online collection system as in claim 1, wherein said online collection exchange module is configured to support multi-lateral trading offers.

26. The online collection system as in claim 25, wherein said multi-lateral trade offers include at least one of conditional trades and simultaneous offers.

27. The online collection system as in claim 1, wherein said online collection redemption module is configured to maintain a list of prizes and to maintain a mapping from sets of said online collectible to said prizes.

28. A method for providing an online collection system to a population of at least one participant, said method comprising:
distributing at least one online collectible;
allocating said at least one online collectible;
maintaining said at least one online collectible;
trading said at least one online collectible; and
redeeming said at least one online collectible for a prize.

29. The method according to claim 28, wherein allocating said at least one online collectible and distributing said at least one online collectible are based on codes to be collected off-line.

30. The method according to claim 28, wherein allocating said at least one online collectible and distributing said at least one online collectible are based on codes to be collected online.

31. The method according to claim 28, wherein maintaining said at least one online collectible includes maintaining a virtual flip-book where said population of at least one participant is viewing said online collectible and is ordering said online collectible, and is viewing additional online collectibles, and is maintaining a wish-list and a trade-list for said online collectible.

32. The method according to claim 28, further comprising:
searching a second collection, said second collection being that of at least a second participant wherein said searching is accomplished according to constraints of said online collection system and constraints of participants of said online collection system.

33. The method according to claim 28, further comprising:
browsing a second collection, said second collection being that of at least a second participant wherein said browsing is accomplished according to constraints of said online collection system and constraints of participants of said online collection system.

34. The method according to claim 28 further comprising:
expressing barter offers, said expressing barter offers includes using a chat capability and said expressing barter offers includes using a formal language.

35. The method according to claim 34, wherein said expressing barter offers include specifying exchanges using a formal logical language, said formal logical language having well-defined semantics, said well-defined semantics allow for communication with complex barter offers while preventing improper use of self-generated messages.

36. The method according to claim 28, further comprising:
negotiating barter offers, said negotiating includes using a chat capability and said negotiating includes using a formal language.

37. The method according to claim 36, wherein said negotiating barter offers include specifying exchanges using a formal logical language, said formal logical language having well-defined semantics, said well-defined semantics allow for communication with complex barter offers while preventing improper use of self-generated messages.

38. The method according to claim 28 wherein said at least one participant is able to barter collectibles in at least one of a bi-lateral and multi-lateral fashion, where automatic barters as well as participant-directed barters are supported.

39. The method according to claim 28, wherein prizes are allocated based on the completion of parts of a collection.

40. A method for providing an online collection system to at least one participant, said method comprising:
expressing barter offers, said barter offers include collection system support for a clearing function, said clearing function allows for circular barters.

41. The method according to claim 40, wherein said circular barters include participants specifying particular pieces said participants wish to trade.

42. The method according to claim 41, wherein said online collection system aggregates said pieces said participants wish to trade, and said online collection system communicates information about said pieces said participants wish to trade to other participants.

43. The method according to claim 40, wherein said expressing barter offers include heterogeneous barter.

44. The method according to claim 43, wherein said heterogeneous barter is barter having offers contain both pieces and points.

45. The method according to claim 44, wherein said heterogeneous barter include participants aggregating said pieces said participants may wish to trade, communicating information about said pieces said participants may wish to trade, allowing additional payments associated with said trade, specifying willingness to perform said trade, given that said additional payment will be received, offering a particular additional payment in said trade.
